(19) United States
(12) Patent Application Publication
(10) Pub. No.: US 2005/0154576 A1
(43) Pub. Date: Jul. 14, 2005

(54) Policy simulator for analyzing autonomic system management policy of a computer system

(75) Inventors: Toshiaki Tarui, Sagamihara (JP); Mineyoshi Masuda, Kunitachi (JP); Tatsuo Higuchi, Fuchu (JP)

Correspondence Address: Stanley P. Fisher;Reed Smith LLP, Suite 1400, 3110 Fairview Park Drive, Falls Church, VA, 22042-4503, US

(73) Assignee: Hitachi, Ltd.

(21) Appl. No.: 10/927,618

(22) Filed: Aug. 27, 2004

(30) Foreign Application Priority Data
Jan. 9, 2004 (JP) 2004-003600

(51) Int. Cl. G06F 9/45

(52) U.S. Cl. 703/22; 703/13

(57) ABSTRACT

Disclosed here is a simulator for simulating the propriety of each created policy less-expensively and fast in an autonomic management system controlled by a policy. The simulator that analyzes the behavior of the above described autonomic management system that receives information inputs of system configuration, load balance setting, system load conditions, software performance, software's transitional performance, and target autonomic management policy to calculate the system behavior (resource utilization rate, software response time, and system throughput) by giving consideration to the system's transitional behavior at a time, then apply an autonomic management policy to the behavior, determine the system configuration and load balance setting at the next time, and use the new system configuration and load balance setting for the next time simulation.

### CLAIM OF PRIORITY

The present application claims priority from Japanese application JP 2004-003600 filed on Jan. 9, 2004, the content of which is hereby incorporated by reference into this application.

### FIELD OF THE INVENTION

The present invention relates to a system for managing a group of computers autonomically and more particularly to simulating means for simulating autonomic management policies.

### BACKGROUND OF THE INVENTION

Current data centers and corporation information systems are expanding in scale and complicated in function dramatically, they are often confronted with a serious problems that lead to increase of the operation/management load. Accordingly, it is required for all the IT systems in the future indispensably to reduce the load of the respective system managers. In these days, an autonomic management systems are proposed to solve the above problem. An autonomic system solves the above problem by managing a server farm of data centers/corporation information systems automatically according to system load.

U.S. 2002/0059427 A2 discloses an autonomic management technique employed for a 3-tier data center (3-tier Web system). According to the technique, in the three-tier (Web servers tier, application servers tier, and data base servers tier) Web system which supports a plurality of customer corporations, standby servers shared by customer corporations are provided in addition to those servers used for customer corporation's operations. A standby server is allocated to a customer corporation according to the customer's load so that the service level of the system is maintained even at the time of abrupt access concentration. To achieve above object, the system is further provided with a management server that monitors the operation state of each server in the system to allocate/de-allocate a server according to the system load in accordance with an autonomic management policy determined beforehand.

An autonomic management policy is a description of conditions for switching a standby server to an active server (server allocation) or switching an active server to a standby server (server de-allocation). In the above example, the system monitors the utilization rate of each server to compare the rate with a predetermined threshold value to determine allocation/de-allocation of a server. Concretely, if the utilization rate of the servers exceeds the threshold value, the management server determines the situation as overload, then allocates the necessary number of servers to the system. If the utilization rate of the servers is under the threshold value, the management server determines the number of servers as excessive and de-allocates some of the allocated servers from the system. When a server is allocated to the system, the management server changes the setting parameters of the load balancer or the setting of the load balancing program in the former tire so that the system load is balanced equally among all the servers including the newly allocated one in the system. Similarly, if any server is de-allocated from the system, the management server changes the setting of the load balancer or load balancing program in the former tire so that the load is balanced equally again among all the rest servers in the system. In the 3-tire Web system, the above processes must be executed in all the tire of the Web server, the application server, and the database server separately.

On the other hand, an autonomic management policy is described in detail in “Server-Allocation Policy for Improving Response to Web Access Peaks” of Systems and Computers in Japan, Vol. 35, No. 5, 2004, pp. 55-66. The autonomic management policy cannot be achieved by simply allocating/de-allocating a server according to a threshold value. The following complicated conditions should be satisfied comprehensively to create such a policy.

The duration if the threshold value is satisfied
The elapsed time since the subject server is de-allocated as a standby one previously
Allocation timing of a server in another tier

[Patent document 1] U.S. 2002/0059427 A2

[Non-patent document 1] “Server-Allocation Policy for Improving Response to Web Access Peaks” of Systems and Computers in Japan, Vol. 35, No. 5, 2004, pp. 55-66, Translated from Denshi Joho Tsushin Gakkai Ronbunshi, Vol. J85-D-I, No. 9, September 2002, pp. 866-876.

If the above conventional technique is used for autonomic management of a system, the verification of the autonomic management policy is difficult. That has been a conventional problem.

In each data center/corporation information system, system configuration, application program, input request amount (change with time) of system load, and required service level (response time, etc.) differ among systems. Consequently, an autonomic management policy must be created for each system separately.

For example, the threshold value in the above first known example must be set for each system separately. A problem that might arise here is how to confirm the correct operation of the system with the autonomic management policy. Concretely, if the CPU utilization rate that is assumed as a server allocation threshold value is set at 80%, it is required to verify whether or not the threshold value can prevent response delay at the time of access concentration. If the threshold value is too high, the server allocation is delayed, thereby the server is overloaded and the system service level cannot be maintained. On the contrary, if the threshold value is too low, the excessive server allocation causes an increase of the cost which is not acceptable, although the system service level is maintained. This is why the threshold value must be determined properly so as to satisfy the trade-off between the cost and the service level.

In addition, because the server behavior is affected strongly by the transitional behavior of the cache, etc. (elements to be changed with time), such server transitional behavior must be taken into consideration to create a policy. Hereunder, how such a server's transitional behavior will affect an object policy will be described with reference to FIGS. 5A through 7C. FIG. 5A shows the initial state of a three-tier Web system used for autonomic management and FIG. 5B shows a configuration of the Web system to which a DB server is added. In the initial state (FIG. 5A), the system is provided with a Web server 3100, an AP (Application) server 3200, and a DB (Data Base) server 3300, and those servers process requests from clients 3500. The DB server processes using data stored in a storage device 3400. In the Web, AP, and DB tiers, standby servers 3110, 3210, and 3310 are provided respectively. In FIG. 5B, the standby DB server 3310 is added as an active server through an autonomic management processing because current DB server is overloaded and, as a result, the standby DB server 3310 is ready to accept a processing requested from the client.

FIG. 6A shows how the workload of the system changes with time and FIG. 6B shows how the response time of the system changes with time when no autonomic management is done. If the workload increases sharply at a time A and no autonomic management is done (the system configuration shown in FIG. 5A is continued for the processing), the response time is increased after the time A as shown in FIG. 6B. Consequently, as the system's response time goes over the upper limit 4011 if the system configuration is not changed, the autonomic management mechanism of the system begins to work, thereby another DB server is added (the number of DB servers thus becomes 2) as shown in FIG. 6C. The system configuration is thus changed as shown in FIG. 6B. It is premised here that only the DB server is a bottleneck and both of the Web and AP servers are not bottlenecks in the system. After the time B, therefore, the load is balanced between the two DB servers based on a round robin, thereby it is expected that the DB server processing capacity become double and the response time is reduced. Actually, however, because of the transitional behavior of the system caused by a cache, the response time does not decrease so easily. Hereunder, the reason will be described.

FIG. 7A shows how the performance of the added DB server changes and FIG. 7B shows how the response time of the system changes. If the number of DB servers increases from one to two in the subject system, the response time is expected ideally to decrease as shown with a dotted line 4041 in FIG. 7B. Actually, however, the response time increases sharply once as shown with a solid line 4040. The data cache of the added DB server causes such an increase of the response time. Just after another DB server 3310 is added to the system in an autonomic management process, the added DB server 3310 has no data in its cache (cold cache) and the performance of the added DB server 3310 is low. As data is accumulated in the cache after that, the performance of the DB server 3310 is improved and finally restored almost to the same level of the existing DB server 3300. If the performance of the existing DB server 3300 is assumed to be 100%; therefore, the performance of the added DB server 3310 comes to be improved gradually from the time B as shown with a curve in FIG. 7A. It is assumed here that the time at which the performance of the added DB server becomes the same as that of the existing DB server is C. If the DB server load is simply distributed between the existing and added DB servers based on a round robin regardless of the above-described difference of performance between the existing DB server and the added DB server, requests come to be queued in the low performance added DB server. As a result, the total performance of the system is significantly degraded, resulting in the degradation of the performance as shown in FIG. 7B.

The above behavior is caused by the load distribution executed without giving any consideration to the difference of the performance between those servers. Also, to avoid such a problem, the server load must be distributed among servers in accordance with the performance of each server. FIG. 7C shows a load balancing policy for avoiding such a problem. Instead of allocating half of the existing DB server load to the newly allocated DB server when the number of DB servers is changed from one to two (at the time B), the load to the added DB server should increase step by step (4060 in FIG. 7C) and, finally, the load is balanced equally between the servers at time C at which the performance is equalized between two servers. If a new DB server is added in an autonomic management process, this load balancing policy can be applied to the system so that the added DB server 3310 is prevented from being over-loaded excessively while its performance is still low, thereby the system performance is prevented from degradation. Like this example, the autonomic management policy is required not only to describe a threshold value for adding/deleting a server simply, but also to describe load balancing policies which consider the transitional behavior of the server performance, as well as load duration, server allocation history, etc. as described in the second known example.

As described above, the system response time includes complicated elements such as a transitional change of server performance. Such complicated elements as the transitional behavior of server performance should be taken into consideration to create complicated policies used in autonomic management. Also, no manual checks can cope with the verification of the property of an autonomic management policy created for a site; at the present time, there is no way except the verification carried out with actual systems. This is why such policy verification requires significant cost. In addition, because it is only after the actual system is completed to make such policy verification, the system construction period is often extended and this has been one of the conventional problems.

### SUMMARY OF THE INVENTION

Under such circumstances, it is an object of the present invention to provide an autonomic management policy simulator that can verify the propriety of each created policy less-expensively and fast in an autonomic management system operated under the control of the subject policy.

In order to achieve the above object, the autonomic management policy simulator of the present invention inputs information items of autonomic management policy, system configuration for servers allocated to the subject processing, workload change with time, performance of the program to run in the system, transitional characteristic of the performance of the program, and outputs a system behavior (information items of throughput, response time, and resource utilization rate).

Furthermore, in order to simulate a system behavior including the transitional status in a system of which configuration is to be changed with time due to its autonomic management function, the simulator obtains the system configuration, load balance setting, and load information to be inputted at a time respectively, then calculates the resource utilization rate, the application response time, and the system throughput at that time, on the basis of the obtained information items and by giving consideration to the transitional behavior of the system. Furthermore, the simulator applies above-mentioned result to the autonomic management policies and determines which policy should be used. After that, the simulator uses the autonomic management policy to determine the system configuration and the load balance setting for the next time interval. The simulator then puts forward the time to repeat the system behavior simulation at the next time interval. By repeating the above operations, the simulator can simulate the system behavior by changing the system configuration according to the autonomic management policy. Furthermore, the simulator can also simulate a system behavior by giving consideration to the transitional status of the software. The simulator can also make a decision for autonomic management on the basis of the system behavior determined by giving consideration to the transitional characteristic of the software.

According to the present invention, no real system is required to simulate whether or not each created policy functions as expected in an autonomic management system under the control of the subject policy, thereby the simulation cost is minimized and the simulation is speeded up. In addition, when such a simulation is carried out in the autonomic management system, the transitional responses of the software are taken into consideration to simulate a system behavior, so that the system behavior is simulated accurately.

### BRIEF DESCRIPTION OF THE DRAWINGS

FIG. 1 is a block diagram of an input/output block of a policy simulator in an embodiment of the present invention;

FIG. 2 is a functional block diagram of an inner configuration of the policy simulator in the embodiment of the present invention;

FIG. 3 is a flowchart of the operation of the policy simulator in the embodiment of the present invention;

FIG. 4 is an input/output screen of the policy simulator in the embodiment of the present invention;

FIG. 5 is the state of a three-tier Web system to be simulated after and before servers are added to the system;

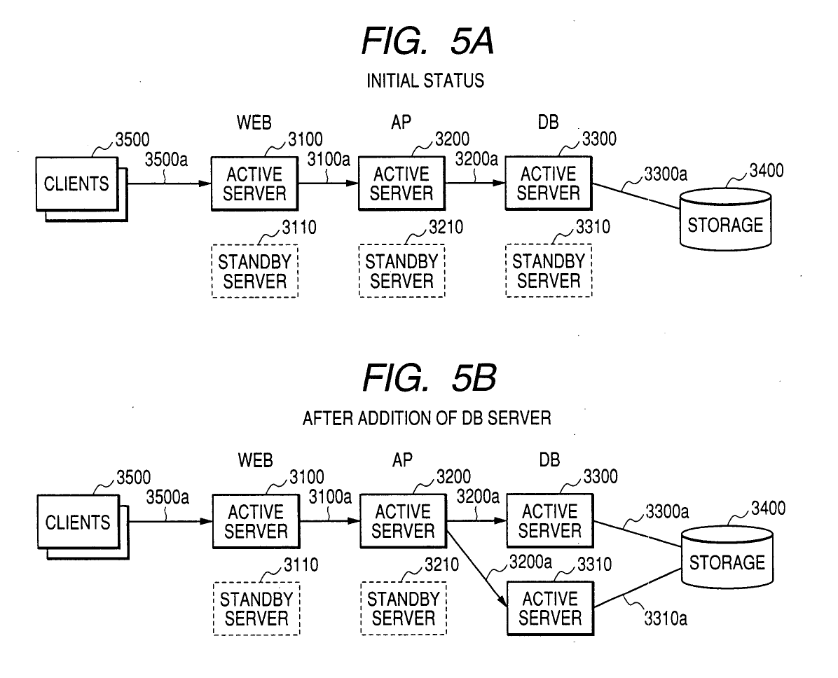

FIG. 6 is a behavior of the three-tier Web system with respect to an autonomic management process;

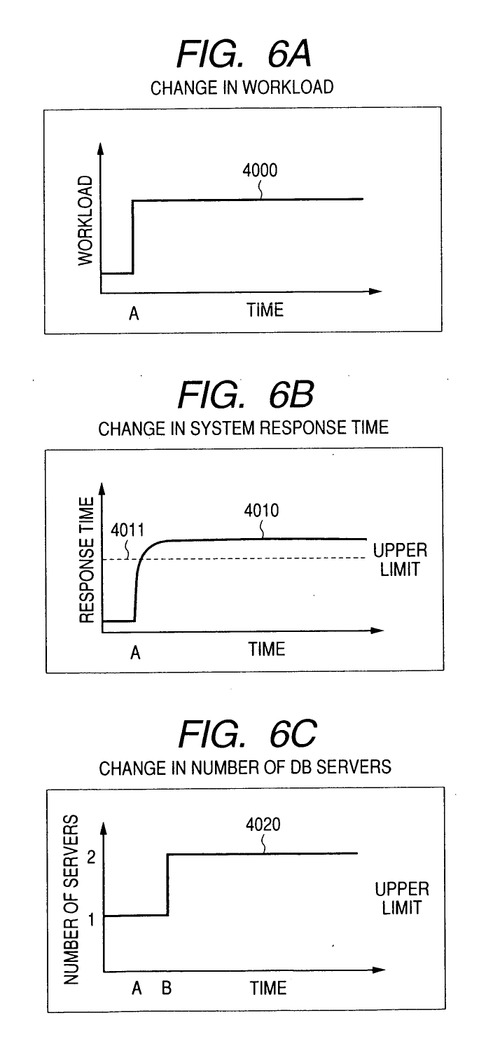

FIG. 7 is a transitional behavior of the three-tier Web system with respect to the autonomic management process;

FIG. 8 is a block diagram of the three-tier Web system;

FIG. 9 is a block diagram of a storage system to be controlled; and

FIG. 10 is an example of describing an autonomic management policy in the embodiment of the present invention.

### DETAILED DESCRIPTION OF THE PREFERRED EMBODIMENTS

Hereunder, the preferred embodiments (simulator) of the present invention will be described in detail with reference to the accompanying drawings.

### First Embodiment

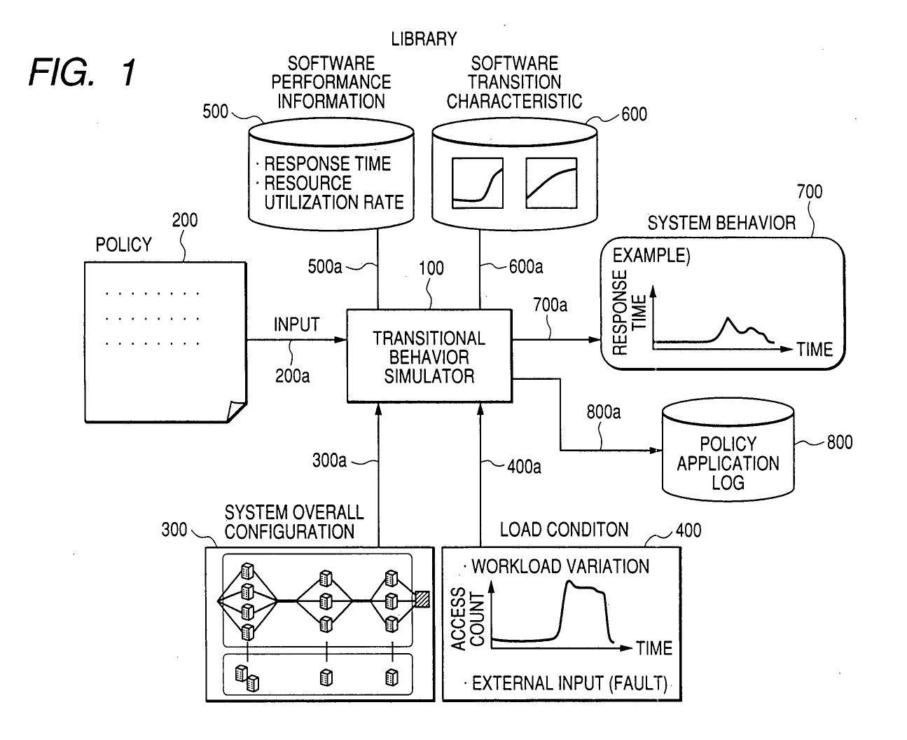

FIG. 1 is a block diagram of an input/output block of a simulator in the first embodiment of the present invention. The simulator 100 inputs information items of autonomic management policy 200, overall system configuration 400, load condition 400 denoting a load amount (the number of accesses) change with time, which is inputted to the system, library 500 for denoting the performance (software's utilization of each resource such as the CPU and software's response time), and a library for denoting the transitional performance characteristic of the software. The load condition 400 defines not only workload variations, but also server faults, etc. which can be consider as external inputs in a broad sense. The simulator outputs a system behavior consisting of a system response time, a resource utilization rate, the number of requests processed by the system (throughput), etc., as well as each policy application log 800 denoting how an autonomic management policy is applied. The simulator inputs system load changes with time as a load condition 400 together with the information of software transitional performance 600 for carrying out a simulation by taking the system's transitional performance into consideration.

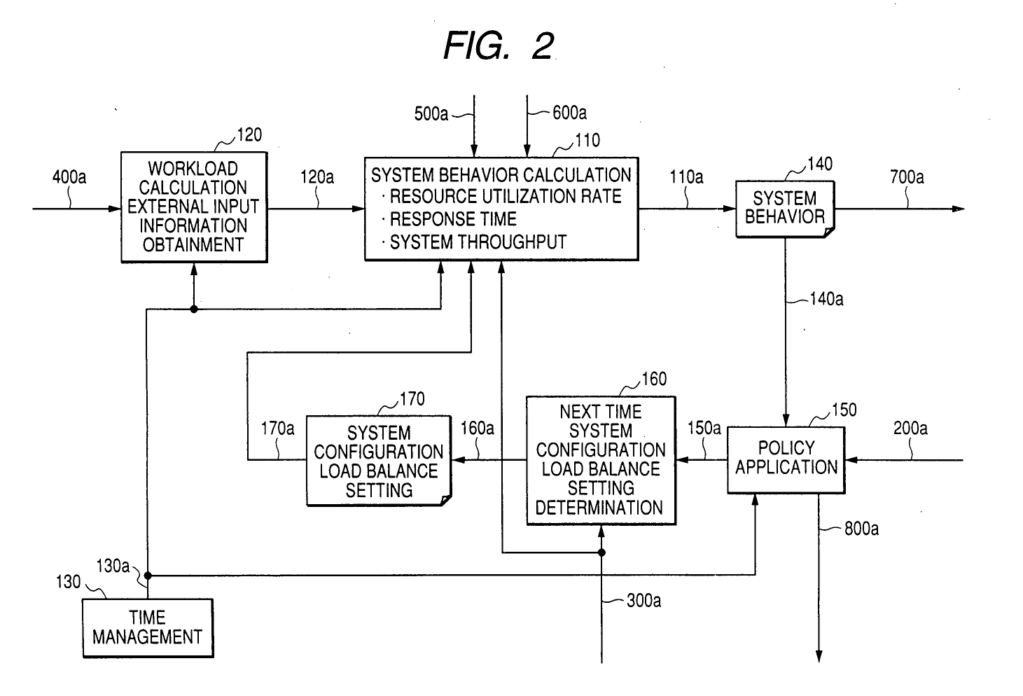

FIG. 2 is a functional block diagram of the simulator 100 in its inner configuration. Reference numeral 130 denotes a time management function that is a pseudo clock denoting the current time on which the simulator is making a simulation. Reference numeral 120 denotes a function for calculating the workload of the system to be simulated. The function obtains a workload amount at a time denoted by the time management function. The function can also obtain external input information including a server fault, etc. Reference numeral 110 denotes a system behavior calculating function. The function 110 calculates a system behavior (response time, resource utilization rate, throughput) 140 according to the system workload calculated by the function 120, the current system configuration and load balance setting 170, the library software performance information 500, and the transitional performance characteristic 600. Reference numeral 150 denotes a policy applying function that selects a policy appropriately to the current system behavior from among the policies 200 to be simulated on the basis of the system behavior calculated this time. Reference numeral 160 denotes a function for determining the system configuration and the load balance setting 170 for the next time interval by applying the policy selected by the function 150 to the current system.

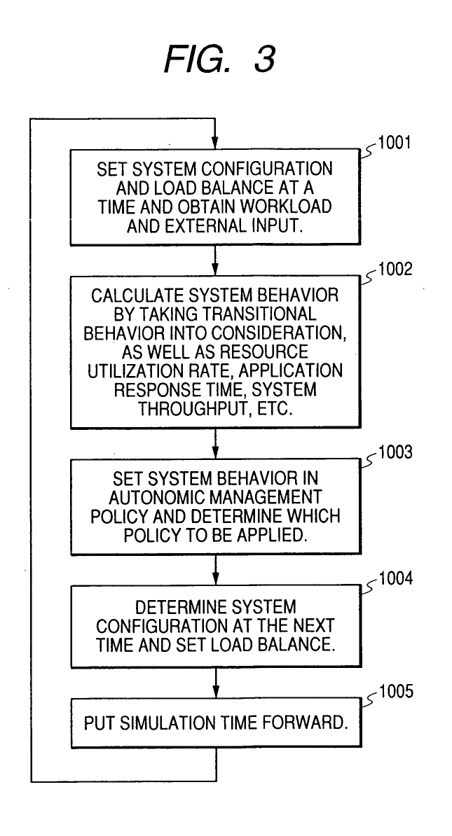

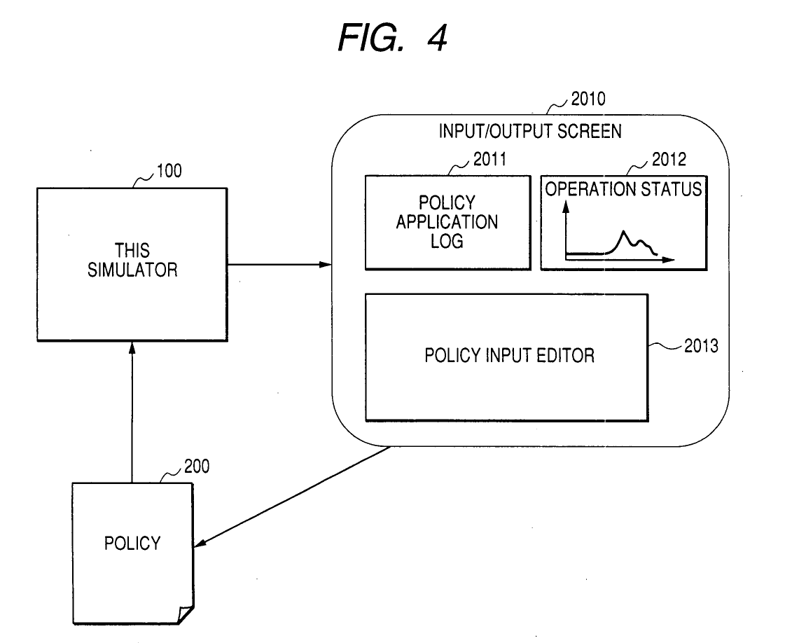

FIG. 3 is a flowchart of the operation of the simulator 100. The simulator 100 repeats the sequence of the processes shown in FIG. 3. FIG. 4 is a policy input/output screen for optimizing an object policy by fed-backing simulation results obtained by the simulator 100. The operator observes the result of the simulation according to the created policy on the screen 2010 shown in FIG. 4 to improve the created policy.

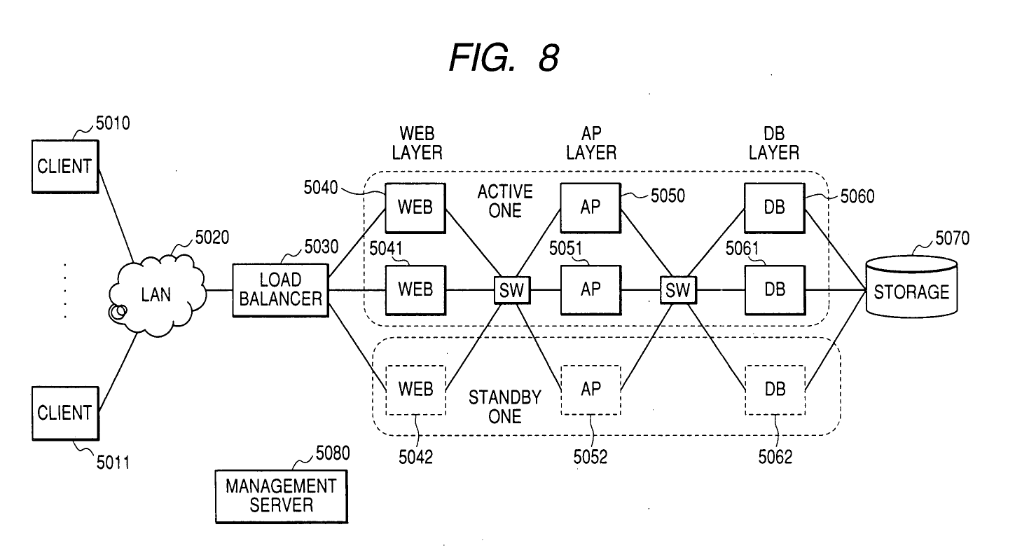

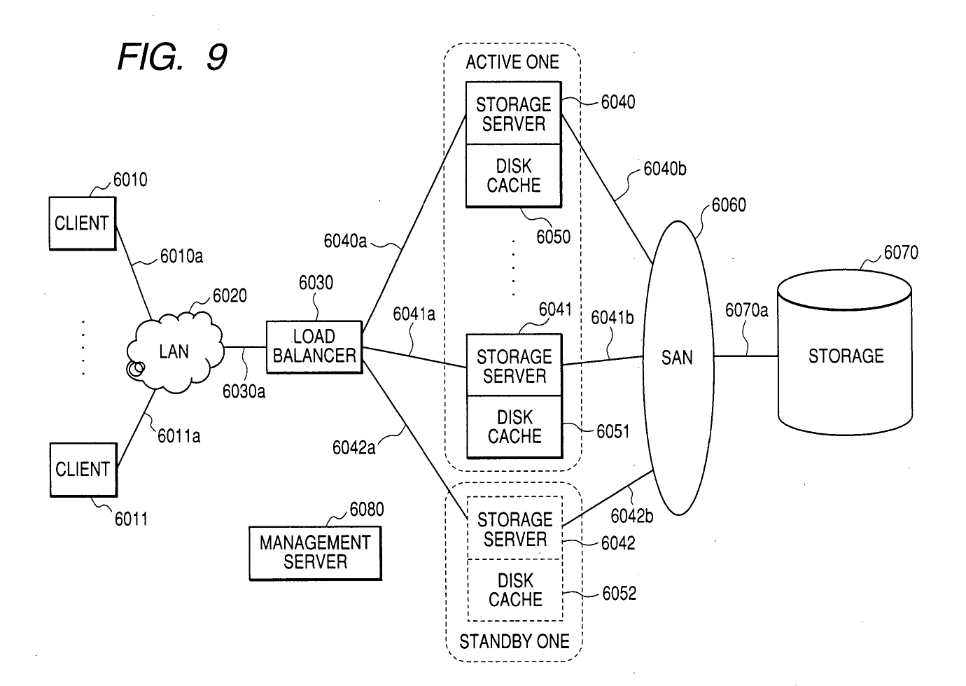

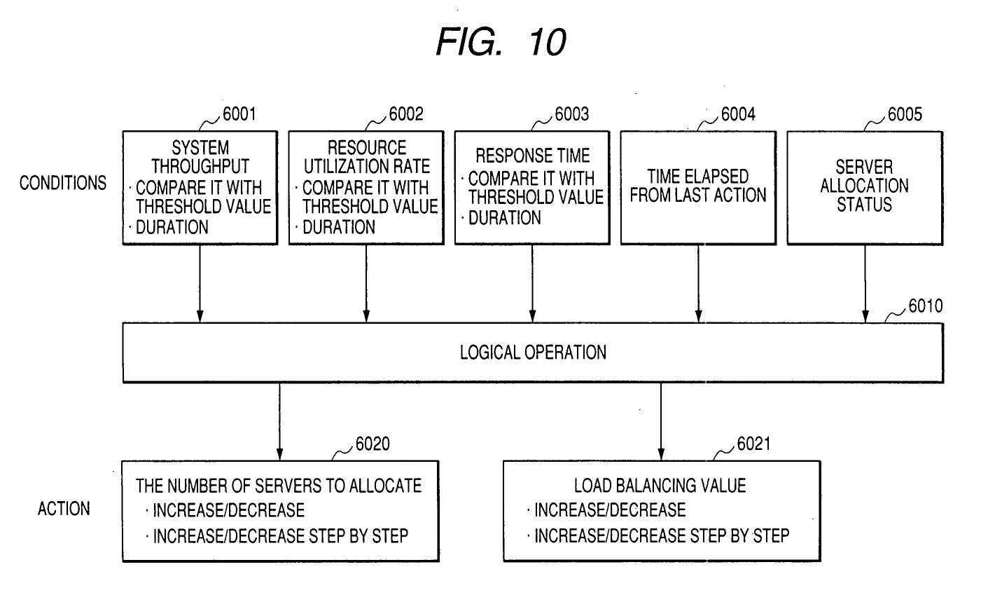

FIG. 8 is a three-tier Web system to be simulated according to the present invention. The Web system increases/decreases the number of servers in each of the three tiers automatically according to server load through autonomic management. FIG. 9 is an InBound storage server connected to a LAN. Each server has a disk cache, so that the system's transitional behavior should be taken into consideration to create each policy. FIG. 10 is an example of a policy describing method.

The present invention is characterized in that the policy simulator 100 calculates the system behavior by taking workload variation and external input 400, as well as software transitional characteristic 600 into consideration, then applying an autonomic management policy to the obtained system behavior to put forward the simulation.

Hereinafter, the operation of the simulator in this first embodiment will be described in detail with reference to FIGS. 1 through 4, as well as FIGS. 8 through 10.

FIG. 8 is an example of a system configuration to be simulated. The system shown in FIG. 8 is three-tire system consists of Web/application/DB tire. The system is consists of two active servers in each tier 5040 and 5041, 5050 and 5051, and 5060 and 5061, one standby server in each tier 5042, 5052, and 5062. The management server 5080 makes autonomic management according to each policy, to activate a standby server into an active server according to the system load; thereby, preventing the system server from being overloaded and maintaining the system response time at a certain value. The details of how to control such an autonomic management system is already well known, so that the description will be omitted here. In such a system, a complicated autonomic management policy is indispensable. The system's transitional behavior is taken into consideration as described in the conventional technique, etc. It is very difficult to verify an autonomic management policy that runs in the management server 5080, however. The simulator of the present invention is intended to verify the operation of such an autonomic management policy.

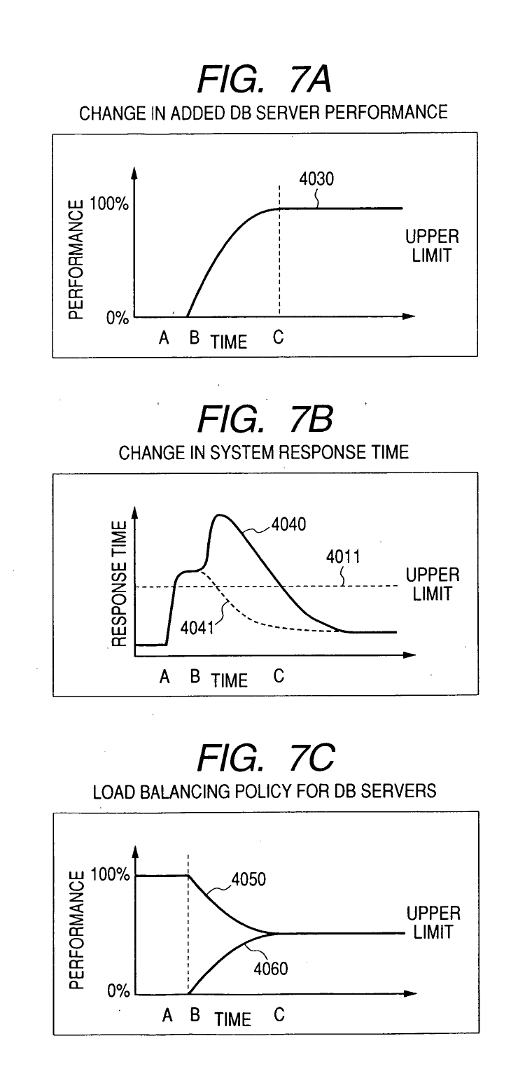

The simulator in this embodiment can apply not only to a Web system, but also to a storage system as shown in FIG. 9. In the figure, a standby storage server 6042 is added to the system consisting of the active storage servers 6040 to 6041, so that the standby storage server is activated according to the system load, thereby avoiding the system response time from slowing down. Even in this example, each storage server has a disk cache 5050 to 5052, so that it is often confronted with a problem that the performance of the storage server just after it is activated is slower than the performance of any of the active storage servers. This is why the system requires a load balance policy, as shown in FIG. 7C, which takes into account the transitional performance difference between those storage servers. In that case, therefore, proper verification of the autonomic management policy is required.

FIG. 10 is an example of how to describe an autonomic management policy. A policy is roughly divided into items of condition, logical expression (of the conditions), and autonomic management action (when the logical expression is satisfied). The condition consists of information items of system throughput (the number of transactions, etc.), utilization rate of each system resource (CPU, network, disk, etc.), application response time, result of comparison of the system response time with its threshold value, duration when the response time is over/under the threshold value, and time elapsed from the last autonomic management control action. The autonomic management action is increasing/decreasing the number of servers and/or an amount of load to be distributed to a server, as well as increasing/decreasing the number of servers and/or an amount of load to be distributed to a server step by step. Combination of those conditions and the autonomic management actions are used to describe an autonomic management action. For example, a policy can be created as follows.

A standby server is activated if an active server's CPU utilization rate is over 80%.

The load value of the newly added server should be changed in accordance with the expression shown in FIG. 7C.

A new policy must be created in accordance with the system configuration, the running program, the system workload, and the user requested service level.

The policy simulator 100 simulates each policy as described above to check its propriety. As shown in FIG. 1, the policy simulator inputs the following items.

(1) Autonomic Management Policy 200

Policy used for autonomic management described in FIG. 10.

(2) Overall System Configuration 300

Overall configuration of the system (including standby servers) to be controlled by the subject policy as shown in FIGS. 8 and 9. In this patent, the configuration of servers (excluding standby ones) allocated for a processing and used actually by the system is referred to as “system configuration”, and this configuration is distinguished from the “overall system configuration” that includes standby servers. The active servers in the system overall configuration is equal to the system configuration in the initial status of simulation. In the system overall configuration, the physical topology, as well as the performance of each server, each network, and each storage are described.

(3) Load Condition 400

Time change (estimated value) of workload of simulated system (the number of requests received from user clients, etc.). With this value, for example, the autonomic management system behavior can be simulated at the time of abrupt concentration of accesses. On the other hand, one of the important goals of the autonomic management system is to cope with external disturbance such as server failure, in which case automatic allocation of an alternate server is required. Ability to describe such external disturbances among the load conditions enable simulation of such external disturbances as a server fault, etc. For example, the external disturbance description is made as follows.
Time 500 sec: DB server 1 fault
   (4) Software Performance Information 500

Both response time and resource utilization rate of the software on the simulated system are described in the steady state. For example, the description will be made as follows.
DB tier transaction: average response time 1 ms/request
   Average resource utilization rate for 1 GHz Pentium (registered trademark) CPU: 0.5 ms/request
   (Although utilization of both network and disk must be described, the description will be omitted here.)

They are basic values for calculating the system performance.

(5) Software Transitional Characteristic 600

This library describes the transitional characteristic of the subject software. One of the methods for describing a transitional behavior of the system is to describe the system performance changes with time after a transitional behavior trigger occurs as shown in FIG. 7A. In FIG. 7A, the CPU processing performance is degraded transitionally and the system throughput is represented by a percentage of throughput at the normal time. In addition, if a transitional overhead occurs, the utilization of the CPU may be denoted as a percentage of that at the normal time (the value could be over 100%). When combined with (4), the system performance including the transitional behavior can be obtained.

The simulator 100 outputs the following:

(1) System Behavior 700

System behavior data changes with time. Concretely, the time change of system response time, utilization rate of each resource (CPU, network, disk, etc.), system throughput (the number of processing requests), etc. This data is used to check whether or not the system is operating as expected in accordance with a target service level.

(2) Policy Application Log 800

This log denotes how each policy is applied to the system. The log retains items of time, applied policy identifier, and parameter values used for decision of the application of object policy. This log also retains how each server is allocated by the autonomic management server. When combined with (1), each created policy is debugged and simulation results are fed back to optimize the policy if the created policy does not work as expected.

Next, the operation of the simulator will be described in detail with reference to FIGS. 2 and 3. This autonomic management system simulator repeats the following operations in each simulation cycle.

(1) Recognition of the system operation at the subject time

(2) Applying an autonomic management policy according to the result of (1).

(3) Deciding both system configuration and load balance setting for the next time step according to the result of (2).

The simulator carries out a simulation for next time interval according to the system configuration and the load balance setting decided in (3). The simulation cycle is determined according to the following points in accordance with the accuracy and simulation speed requirements of each simulator.

If the simulation cycle is short, the simulation accuracy is improved while a longer simulation time is required.

If the simulation cycle is long, the simulation is speeded up while the accuracy is lowered.

The simulation must be carried out in a cycle shorter than the transitional system behavior that should be avoided in the system to be simulated (otherwise, the transitional behavior evaluation accuracy is degraded significantly).

Hereinafter, the operation of the simulator in each simulation cycle will be described in detail.

At first, the simulator obtains the system configuration and load balance setting 170 in the current simulation cycle, as well as the system workload and the external input information (step 1001). The system configuration and load balance setting 170 are usually obtained from policy application of previous time interval 160. In the first simulation cycle, the initial active server configuration and the default load balance setting denoted in the system overall configuration 300 are used. The system workload and the external input information are obtained by reading the information for the current simulation cycle from the load condition 400 using the workload calculating function 120.

After that, the simulator calculates the system behavior 140 such as each system resource utilization rate, response time, system throughput, etc. using the information of the system configuration and the workload obtained in step 1001, as well as the software performance information library 500 and the software transitional characteristic library 600 (step 1002). The following is an example of the calculation.

(1) Obtaining the software performance information (response time and resource utilization rate) from the performance information library 500

(2) Obtaining a transitional characteristic value at the current time from the transitional characteristic library 600. For example, in FIG. 7A, using elapsed time after the allocation of an added DB server and applying it to the transitional characteristic graph, we can figure-out what percentage (%) of the normal CPU performance can be achieved by CPU at this time interval.

(3) Usage of devices corresponding to external disturbance such as a fault is inhibited in the system configuration 170. The subject devices cannot be used for calculating the system behavior in (4).

(4) The system behavior is calculated according to the information of usable devices obtained in (3), the load balance setting 170, the performance of each hardware component such as CPU, etc. obtained from the system overall configuration 300, and the performance information obtained in (1). At that time, the above information is modified by the transitional characteristic information obtained in (2). For example,
What percentage of performance is degraded at current CPU compared with normal CPU performance?
What percentage of overhead is increased at current software compared with normal software overhead?

The value is modified according to above mentioned results.

Using the above value, the system behavior (utilization rate of each resource such as CPU, response time, system throughput) is accumulated. If the utilization of a resource is over 100%, response time is increased to reflect the effect of waiting time.

The calculated system behavior is output as a simulator output 700.

In the next step, the simulator determines which of the autonomic management policies 200 can be applied according to the system behavior 140 calculated in step 1002 (step 1003). Concretely, in order to make above mentioned decision the system behavior 140 is applied to the autonomic management policy conditions 6001 to 6003 described in FIG. 10 and the condition 6004 is determined according to the current time and the policy application record. In addition, the simulator determines the server allocation state 6005 to make the final decision 6010 for whether or not the subject policy is applicable. The time 6004 consumed since the last action means, for example, a policy such as “after an active server is de-allocated into a standby server, the de-allocated server cannot be allocated to any other processing for five seconds”. The server allocation status means such a policy “up to four servers can be allocated to the subject user”. If a policy is determined to be applicable, the policy information is stored in the policy application log 800.

After determining a policy to be applied in step 1003, the simulator applies the policy to the current system configuration and the load balance setting using the next time system configuration and load balance setting determination mechanism 160 to determine the system configuration and load balance setting 170 to be used in the next simulation cycle (step 1004). The system configuration mentioned here means configuration information of the active servers. The load balance setting means a method for distributing system load among a plurality of servers. The method may be, for example, a round robin method that distribute load to among plurality of servers according to weight value. Consequently, the simulator can apply an autonomic management policy to the system in accordance with the current system operation status.

Completing the above process, the simulator puts forward the simulation clock (step 1005), then repeats the above process again, starting at the operation in step 1001.

The simulator can thus simulate the target policy operation by taking the autonomic management system transitional information into consideration.

Next, a description will be made for how the simulator optimizes a policy by feeding back simulation results. When creating an autonomic management system policy, it is usually difficult to complete a policy just by one processing; the policy is required to be optimized by the method of trial and error. This simulation tool can observe the simulation result and feed back the result to optimize the policy.

FIG. 4 shows an input/output screen 2010 of the simulator. On the output screen are displayed an operation status output block 2012, a policy application log output block 2011, and a policy input editor block 2013. A policy is optimized in the following steps:

(1) An (initial) policy is inputted with use of the policy editor.

(2) The simulator simulates the autonomic management system behavior.

(3) The simulation result is displayed on the screen 2010.

(4) Observing the operation status 2012, the system behavior is checked whether it has problem or not (for example, whether or not the maximum response time defined by SLA is exceeded in any simulation cycle).
(If there is no problem in system behavior, the optimization is finished.)

(75) If any problem is found, the policy application log 2011 is checked to locate the problem in the policy.

(6) The problem of the policy is corrected using the policy input editor 2013.

(7) New policy is created by feeding back the simulation result. The new policy is used to simulate the system behavior again. (Here, the system returns to (3) to repeat the operations to complete the optimization.)

Thus, the autonomic management system policy is optimized by feeding back simulation results.

Variation

The present invention is not limited only to the embodiment described above; it may apply to various variations, for example, as follows.

(1) In the first embodiment, an optimized policy is obtained by accumulating the resource utilization rate, etc. However, the simulation is made more accurately on the basis of a queuing model.

(2) In the first embodiment, there is only one active server system. In other words, web system of only one user (one corporation) is executed in the system. However, the simulation system of the present invention can simulate behaviors of more than two active systems (when standby servers are shared by a plurality of users/works). In that case, all the behaviors may be simulated in parallel while taking server allocation state of other system into consideration.

(3) In the first embodiment, only server is controlled by the autonomic management system. However, the same simulation method may apply to storage system, network system, etc.

As described above, the present invention can simulate the behavior of automatic management policy, and can be used to verify whether the system behave as expected or not, without using the real system. The present invention can thus be applied to system with many computer resources including a data center, etc. with autonomic management because it can reduce the management load effectively, so that it is expected that the present invention can apply to the field.

1. A policy simulator for an autonomic management system,
wherein said policy simulator analyzes the performance of a computer system used for autonomic management under the control of a policy;
wherein said policy simulator receives inputs of a system configuration consisting of information of a server, a storage device, and a network device allocated to an object system to be analyzed, a workload of said system, information of the performance of software running in said system, and an autonomic management policy of said system; and
wherein said policy simulator outputs a behavior of said system.

2. The policy simulator according to claim 1, wherein said policy simulator outputs an autonomic management policy log.

3. The policy simulator according to claim 1,
wherein said policy simulator inputs information of a transitional performance change of software and outputs a system behavior for which said transitional performance change of said software is taken into consideration.

4. The policy simulator according to claim 1,
wherein said policy simulator inputs such external input information as a system device fault and outputs the system performance by taking said external input into consideration.

5. The policy simulator according to claim 1,
wherein said policy simulator describes a policy by combining conditions and an autonomic management action;
wherein said conditions are a result of comparison between system operation state values such as a throughput, a resource utilization rate, a response time, etc. and their threshold values, a duration, an elapsed time since the last autonomic management action, allocation information of servers, storage devices, and network devices provided in said system, and an autonomic management processing described on the basis of logical operation results of said items; and
wherein said autonomic management action is described on the basis of an increase/decrease of the number of servers, storage devices, network devices that are allocated currently, an increase/decrease or a gradual increase/decrease of an amount of load balancing among said servers, said storage devices, and said network devices, said autonomic management action being to be executed when said conditions are satisfied.

6. The policy simulator according to claim 3,
wherein said policy simulator manages simulation clocks in itself;
wherein said simulator executes a simulation in the following steps:
a step of setting a system configuration for denoting information of servers allocated to said system, load valance to each server, each storage device, and each network device, and obtaining a system workload;
a step of calculating a resource utilization rate, an application response time, the number of processing requests to said system for denoting a system action to be taken in said simulation clock according to the performance information of software and transitional performance change information of said software that runs in said system;
a step of applying a system resource utilization rate, an application response time, the number of system processing requests, etc. for representing a system action calculated in said step to an autonomic management policy;
a step of determining how to change said system configuration and said load balance setting for the next time according to said autonomic management policy; and
a step of using said system configuration and said load balance setting changed in said step in the next simulation clock.

7. A policy optimizing method for a policy base autonomic management system;
wherein said method enables a policy to be applied to a simulator to find a system action and a policy application log to feed back a problem found from said system action and said policy application log to a conventional policy to create a new improved policy, said simulator receiving inputs of a system configuration representing information of servers, storage devices, and network devices allocated to a system to be analyzed, a workload of said system, performance information of software that runs in said system, and an autonomic management policy of said system and outputting an autonomic management policy application log; and
wherein said method enables simulations to be repeated on the basis of said new improved policy to optimize said new policy.
